(19) United States
(12) Patent Application Publication
(10) Pub. No.: US 2025/0088841 A1
(43) Pub. Date: Mar. 13, 2025

(54) Profile State Management for Secure Profile Export to a Target Device

(71) Applicant: Apple Inc., CUPERTINO, CA (US)

(72) Inventors: Hyewon LEE, Cupertino, CA (US); Jean-Marc PADOVA, San Francisco, CA (US); Xiangying YANG, Cupertino, CA (US)

(21) Appl. No.: 18/830,026

(22) Filed: Sep. 10, 2024

Related U.S. Application Data
(60) Provisional application No. 63/581,923, filed on Sep. 11, 2023.

(51) Int. Cl. H04W 8/20; H04W 8/24

(52) U.S. Cl. CPC H04W 8/205; H04W 8/245

(57) ABSTRACT

An apparatus configured to process, based on signaling received from a source device with which a target device is engaging in an embedded subscriber identity module (eSIM) transfer process to transfer an eSIM profile to the target device, a first message comprising a source embedded identity document (EID) of the source device, generate, for transmission to the source device, a second message comprising a target EID of the target device and process, based on signaling received from the source device, a third message comprising the eSIM profile and an identification of a first state that the eSIM profile is in on the source device, wherein the eSIM profile includes an Integrated Circuit Card Identification Number (ICCID).

### PRIORITY/INCORPORATION BY REFERENCE

This application claims priority to U.S. Provisional Application Ser. No. 63/581, 923 filed on Sep. 11, 2023, entitled “Profile State Management for Secure Profile Export,” the entirety of which is incorporated by reference herein.

### BACKGROUND

Existing implementations of User Equipment (UE) embedded subscriber identity module (eSIM) profile export functionality typically aims to replicate the physical action of ejecting and inserting a physical SIM card. However, a major concern for eSIM profile exports is the risk of cloning (i.e., two usable versions of the same eSIM profile on two different UEs).

### SUMMARY

Some example embodiments are related to an apparatus having processing circuitry configured to process, based on signaling received from a source device with which a target device is engaging in an embedded subscriber identity module (eSIM) transfer process to transfer an eSIM profile to the target device, a first message comprising a source embedded identity document (EID) of the source device, generate, for transmission to the source device, a second message comprising a target EID of the target device and process, based on signaling received from the source device, a third message comprising the eSIM profile and an identification of a first state that the eSIM profile is in on the source device, wherein the eSIM profile includes an Integrated Circuit Card Identification Number (ICCID).

Other example embodiments are related to a method for processing, based on signaling received from a source device with which a target device is engaging in an embedded subscriber identity module (eSIM) transfer process to transfer an eSIM profile to the target device, a first message comprising a source embedded identity document (EID) of the source device, generating, for transmission to the source device, a second message comprising a target EID of the target device and processing, based on signaling received from the source device, a third message comprising the eSIM profile and an identification of a first state that the eSIM profile is in on the source device, wherein the eSIM profile includes an Integrated Circuit Card Identification Number (ICCID).

### BRIEF DESCRIPTION OF THE DRAWINGS

FIG. 1 shows an example network arrangement according to various example embodiments.

FIG. 2 shows an example UE according to various example embodiments.

FIG. 3 shows an example base station, according to various example embodiments.

FIG. 4 shows an eSIM Profile state diagram, according to various example embodiments.

FIG. 5 shows a call flow that provides an overview of a process for transferring an eSIM profile from a source to a target according to various example embodiments.

FIG. 6 shows a call flow that shows a successful transfer of an eSIM profile from a source Embedded Universal Integrated Circuit Card (eUICC) to a target eUICC according to various example embodiments.

FIG. 7 shows a call flow that shows an installation failure at a target eUICC when attempting to transfer an eSIM profile from a source eUICC according to various example embodiments.

FIG. 8 shows a call flow for transferring an eSIM profile including operations and logic for preventing abuse of delete stubs according to various example embodiments.

### DETAILED DESCRIPTION

The example embodiments may be further understood with reference to the following description and the related appended drawings, wherein like elements are provided with the same reference numerals. The example embodiments relate to improved handling of eSIM profile transfers to prevent eSIM profile cloning.

The example embodiments are described with regard to a user equipment (UE). However, reference to a UE is merely provided for illustrative purposes. The example embodiments may be utilized with any electronic component that may include eSIM profiles and use the information in those eSIM profiles to establish a connection to a network and is configured with the hardware, software, and/or firmware to exchange information and data with the network. Therefore, the UE as described herein is used to represent any electronic component.

The example embodiments are also described with reference to a 5G New Radio (NR) network. However, the example embodiments may also be implemented in other types of networks, including but not limited to LTE networks, future evolutions of the cellular protocol e.g., 5G-Advanced, 6G, etc.), or any other type of network where eSIM profiles may be used.

Throughout this description, the term “source” refers to the device or component on which an eSIM profile that is to be transferred currently resides, i.e., before the transfer. The term “target” refers to the device or component to which the eSIM profile is to be transferred.

Preventing eSIM profile cloning is an ongoing area of concern in the field of cellular communications. Two competing areas of risk must be balanced for potential solutions. The first area is that if the eSIM profile from the source Embedded Universal Integrated Circuit Card (eUICC) is deleted before the exported package is installed on the target eUICC, the eSIM profile may be completely lost if there is a problem during installation, thereby leaving a user without service on both UEs; this outcome clearly should be avoided. The second risk area is that if an eSIM profile is kept on the source until confirmation that the exported eSIM profile has been installed on the target eUICC, the profile may be considered cloned (e.g., existing on two UEs at the same time). Ideally, there should only be a single useable instance of an eSIM profile on any number of UEs.

The example embodiments relate to a new eSIM profile “secure state” that may be used to prevent eSIM profile cloning. When an eSIM profile is exported from a source eUICC and installed on a target eUICC, it may be in a state that is not usable (e.g., a new “export” state). The export state may prevent certified eUICCs issuer security domain-root (ISD-R) from enabling an eSIM profile in the export state.

The export state may be managed by a certified eUICC. In some example embodiments, the transition from the export state to the disabled state may occur if (1) the source eUICC deletes the original profile, (2) the source eUICC generates a signed deletion stub containing both the Integrated Circuit Card Identification Number (ICCID) of the eSIM profile and the embedded identity document (EID) of the target eUICC, and (3) the target eUICC may then change its eSIM state from export to disabled using the signed payload from the source eUICC as part of the application protocol data unit (APDU) used to disable the profile. The target ISD-R may have the signed payload because without the signed payload, the target ISD-R should delete the eSIM profile. Further details relating to operations and logic of the export eSIM state will be discussed below.

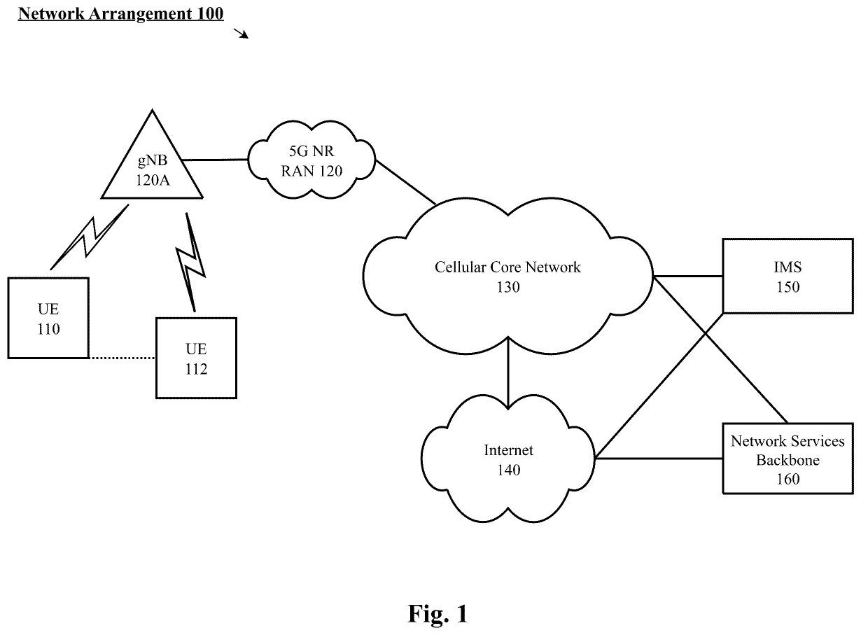

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. The network arrangement 100 also features a UE 112. The UE 112 may be substantially similar in functionality to the UE 110. The UE 110 and the UE 112 may associate with one another by various signaling, including Wi-Fi, Near Field Communication (NFC), and Bluetooth. Thus, the example of two UEs 110 and 112 is merely provided for illustrative purposes. Either the UE 110 or the UE 112 may act as a source or a target for an eSIM transfer.

The UE 110 may be configured to communicate with one or more networks. In the example of the network configuration 100, the network with which the UE 110 may wirelessly communicate is a 5G NR radio access network (RAN) 120. However, the UE 110 may also communicate with other types of networks (e.g., 5G cloud RAN, a next generation RAN (NG-RAN), a legacy cellular network, etc.) and the UE 110 may also communicate with networks over a wired connection. With regard to the example embodiments, the UE 110 may establish a connection with the 5G NR RAN 120. Therefore, the UE 110 may have a 5G NR chipset to communicate with the NR RAN 120.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

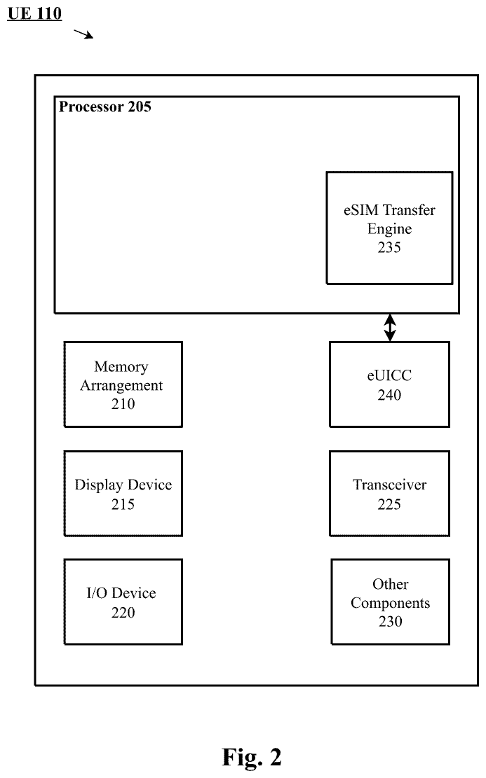

FIG. 2 shows an example UE 110 according to various example embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device (such as a camera), ports to electrically connect the UE 110 to other electronic devices, sensors to detect conditions of the UE 110, etc. An eUICC 240 may be a hardware component embedded into the UE 110 configured to store and/or transfer a number of carrier profiles.

The processor 205 may be configured to execute a plurality of engines for the UE 110. For example, the engines may include an eSIM transfer engine 235 for performing operations related to improved UE handling of eSIM transfers via an export eSIM profile state. The eSIM transfer engine 235 may be implemented on both the UE 110 and the UE 112.

The above referenced engine being an application (e.g., a program) executed by the processor 205 is only an example. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 5G-NR RAN 120. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

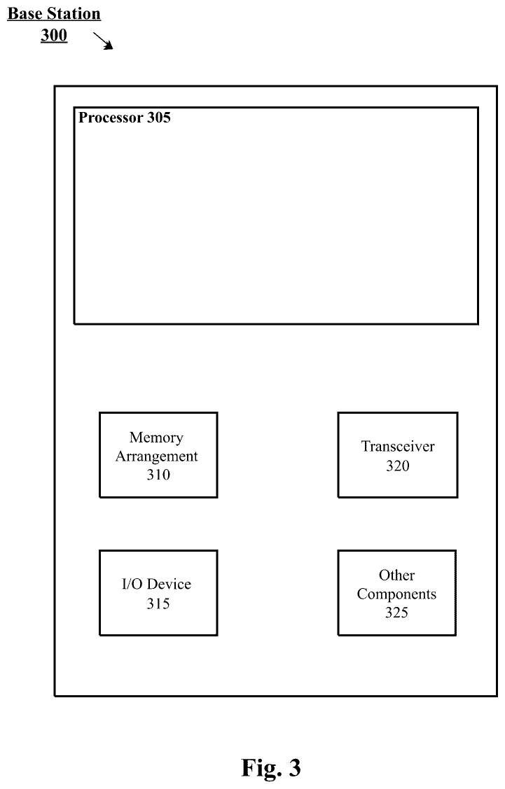

FIG. 3 shows an example base station 300 according to various example embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power Sources, etc.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

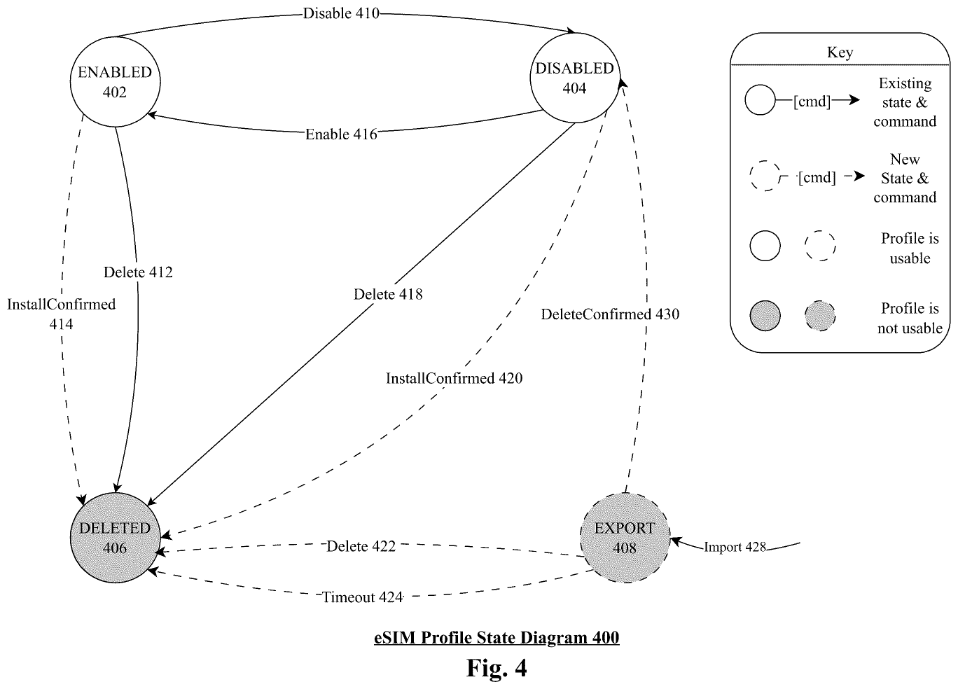

FIG. 4 shows an eSIM profile state diagram 400 according to various example embodiments. The diagram 400 may describe eSIM states and commands from the perspective of an eUICC (e.g., the eUICC 240). The diagram 400 features a key. The key shows that non-dashed circles and lines (e.g., eSIM states and commands) represent existing eSIM states and commands. Conversely, dashed circles and lines indicate newly proposed eSIM states and commands corresponding to the example embodiments. The key indicates that a non-filled circle (e.g., eSIM profile state) is usable by the eUICC 240. The key further indicates that a filled circle is not usable by the eUICC.

The eSIM profile state diagram 400 features an enabled state 402, a disabled state 404, a deleted state 406, and an export state 408. The commands to the eUICC 240 connecting the various eSIM profile states shown in FIG. 4 will be briefly described.

The enabled state 402 may transition to the disabled state 404 by a disable 410 command. The enabled state 402 may transition to the deleted state 406 by a delete 412 command. The enabled state 402 may also transition to the deleted state 406 by an InstallConfirmed command 414. The InstallConfirmed command 414 may, in some example embodiments, be part of an install stub provided to a source eUICC from a target eUICC.

The disabled state 404 may transition to the enabled state 402 by an enable 416 command. The disabled state 404 may transition to the deleted state 406 by a delete command 418. The disabled state 404 may also transition to the deleted state 406 by an InstallConfirmed command 420. The InstallConfirmed command 420 may, in some example embodiments, be part of an install stub provided to a source eUICC from a target eUICC.

The export state 408 may transition to the deleted state 406 by a delete command 422. The export state 408 may also transition to the deleted state 406 following a timeout 424 following an expired timer for arrival of a signed payload at the target eUICC (for example, from the source eUICC). The export state 408 may transition to the disabled state by a DeleteConfirmed command 430, which may be part of a delete stub from a source eUICC. An eSIM profile may be installed on a target in the export state by an import command 428.

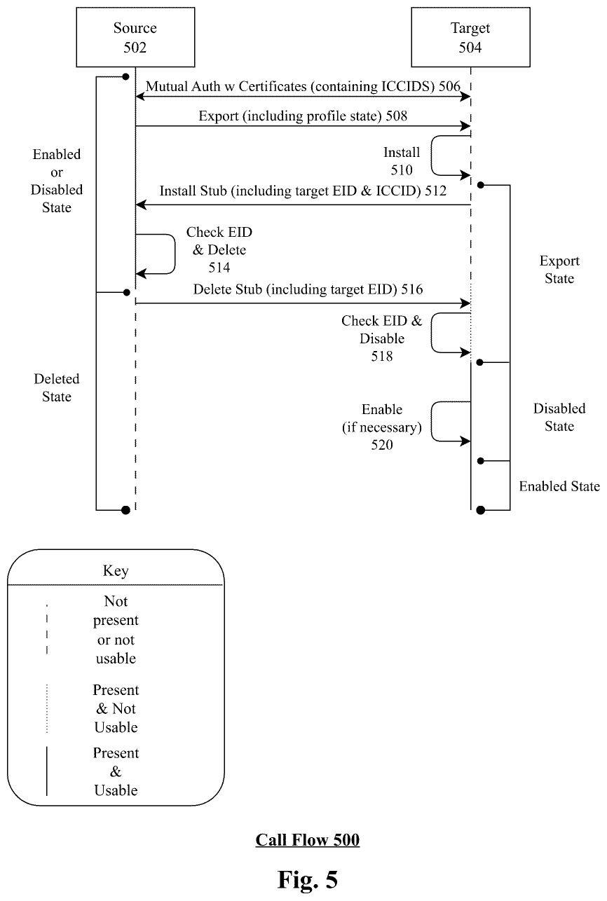

FIG. 5 shows a call flow 500 that provides an overview of a process for transferring an eSIM profile from a source 502 to a target 504 according to various example embodiments. The call flow 500 includes a key showing an associated state of the eSIM profile that is being transferred during various operations that are being performed by the source 502 and target 504 to effect the transfer of the eSIM profile. The portions of the call flow (as shown by the key) with longer dashed lines indicate that an eSIM profile having an associated state is not present or not usable by a corresponding source or target (e.g., a source 502 or a target 504). The portions of the call flow 500 with small dots indicate that the eSIM profile in the associated state of the target 504 is present and not usable. Finally, the solid lines descending from the source 502 and the target 504 indicate that the eSIM profile in the associated state is present and usable.

Initially, the eSIM profile that is to be transferred from the source 502 to the target 504 is in the source 502 in either the enabled or disabled state (operations 506, 508, 512, and 514). The target 504 begins the call flow 500 without any associated state (e.g., the eSIM profile to be transferred is not present on the target 504). In 506, the source 502 and the target 504 perform mutual authentication procedures, including, for example, exchanging certificates containing EIDs of both the source 502 and the target 504.

In 508, the source 502 exports the eSIM profile to the target 504, e.g., the source 502 executes an export command for the eSIM profile and the target 504 executes a corresponding import command. When the eSIM profile is sent to the target 504, the source may include the current profile state of the eSIM profile, e.g., enabled or disabled.

In 510, the target 504 installs the eSIM profile on the eUICC and transitions the eSIM profile to the export state. As described above, the eSIM profile in the export state means that the eSIM profile is present on the target 504 but is not usable.

In 512, when the installation of 510 is successful, the target 504 transmits an install stub message to the source 502, including the target EID and the ICCID. In 514, the source 502 checks the target EID against the target EID received during the authentication procedures 506 and deletes the installed eSIM profile, e.g., the eSIM profile that was exported and identified by the ICCID. Referring back to FIG. 4, the operation 514 corresponds to the eSIM profile being on the source 502 in the enabled state 402 or disabled state 404 and the source 502 performing a respective InstalledConfirmed command 414 or 420 to transition the eSIM profile from the enabled state 402 or disabled state 404 to the deleted state 406. Thus, as shown in FIG. 5, at the conclusion of the operation 514, the eSIM profile on the source 502 transitions to the deleted state.

In the above example, it was considered that the target EIDs match, though if they did not, the eSIM profile on the target 504 would remain in the export state (e.g., unusable) and the eSIM profile on the source 502 would remain in the enabled or disabled state (e.g., useable).

Continuing with the call flow 500, in 516, the source 502 transmits a delete stub, including the target EID and the ICCID to the target 504 to indicate to the target 504 that the source has deleted the eSIM profile identified by the ICCID.

In 518, the target 504 checks the delete stub for the target EID and, if it is correct, transitions the eSIM profile to the disabled stated. Referring to FIG. 4, the operation 518 corresponds to the target 504 performing a DeleteConfirmed command 430 to transition the eSIM profile from the export state 408 to the disabled state 404. At the conclusion of the operation 518, the eSIM profile has been deleted from the source 502 and is in the disabled state on the target 504.

In 520, the eSIM profile on the target 504 transitions to the enabled state. In some example embodiments, the when the eSIM profile is imported and includes an indication of the current state that the eSIM profile was on the source 502 (e.g., enabled or disabled), the target 504 may perform operations to place the SIM profile in the state it was in when on the source 502. For example, if the eSIM profile was in the disabled state on the source 502, the target 504 may not perform the operation 520 and leave the eSIM profile in the disabled state until a user of the target indicates that the eSIM profile should be enabled. If the eSIM profile was in the enabled state on the source 502, the target 504 may automatically (or may prompt the user of the target 504) to perform the operation 520 to transition the eSIM profile from the disabled state to the enabled state.

In other example embodiments where the target 504 is not provided with the state of the eSIM profile when it was on the source 502 (or even if the state was provided), the eSIM profile may remain in the disabled state on the target 504 until a user determines the eSIM profile should be enabled.

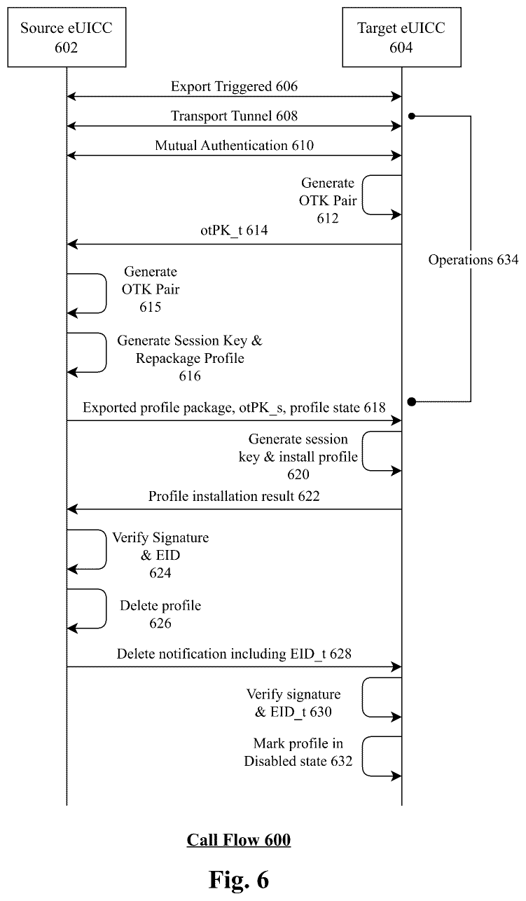

FIG. 6 shows a call flow 600 that shows a successful transfer of an eSIM profile from a source eUICC 602 to a target eUICC 604 according to various example embodiments. The call flow 600 shows a source eUICC 602 and a target eUICC 604; both the source eUICC 602 and the target eUICC 605 feature functionality substantially similar to the eUICC 240.

In 606, an eSIM export operation is triggered between the source eUICC 602 and the target eUICC 604. In 608, a transport tunnel is established between the source eUICC 602 and the target eUICC 604. The transport tunnel may be provisioned by a source or target UE local profile assistant (LPA) and/or a carrier server.

In 610, mutual authentication procedures are performed between the source eUICC 602 and the target eUICC 604. The authentication procedure 610 may include sharing of certificates that include the source eUICC 602 EID and the target eUICC 604 EID.

In 612, the target eUICC 604 generates a one-time key pair. In 614, the target eUICC 604 transmits the public key part of the one-time key pair to the source eUICC 602.

In 615, the source eUICC 602 generates a one-time key pair. In 616, the source eUICC 602 generates a session key and repackages the eSIM profile using the session key.

In 618, the source eUICC 602 transmits a message to the target eUICC 604 including the exported profile package, the public key part of the source one-time key pair, and the profile state.

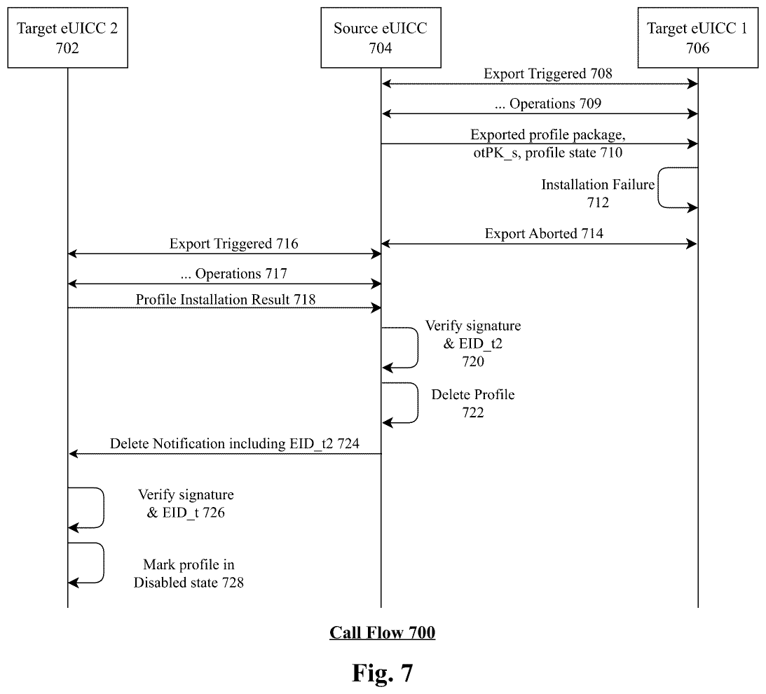

In 620, the target eUICC 604 generates a session key and installs the profile in the export state. In 622, the target eUICC 604 transmits a profile installation result (e.g., a stub) to the source eUICC 602, indicating that the profile has been installed. Operations related to profile installation failure are discussed in FIG. 7. Also shown in the call flow 600 are operations 634, which may encompass the operations as described in 608, 610, 612, 614, 615, and 616. The operations 634 are described as a group for ease of reference in the call flow 700 shown in FIG. 7.

In 624, the source eUICC 602 verifies the signature of the target eUICC 604 and the target EID in the profile installation result. In 626, the source eUICC 602 deletes the installed eSIM profile.

In 628, the source eUICC 602 transmits a delete notification to the target eUICC 604, including the target EID.

In 630, the target eUICC 604 verifies the signature of the source eUICC 602 and target EID. In 632, the target eUICC 604 updates the profile to the disabled state.

In some example embodiments, following 632, the target eUICC 604 may update the profile to the enabled state.

FIG. 7 shows a call flow 700 that shows an installation failure at a target eUICC 706 when attempting to transfer an eSIM profile from a source eUICC 704 according to various example embodiments. The call flow 700 includes a source eUICC 704 which is substantially similar to the source eUICC 602. Also shown in the call flow 700 is a target eUICC 1 706, which is substantially similar to the target eUICC 604. The call flow 700 also includes a target eUICC 2 702, which may be either the eUICC on the same UE as the target eUICC 1 706, or an eUICC on a separate UE from the target eUICC 1 706. In some scenarios, the target eUICC 1 706 may fail to install a transferred eSIM profile. The call flow 700 demonstrates an example fallback procedure to further prevent eSIM stranding (e.g., leaving a user with no functioning eSIM on either a source or a target UE).

In 708, an eSIM export operation is triggered between the source eUICC 704 and the target eUICC 1 706.

In 709, the source eUICC 704 and the target eUICC 1 706 perform various operations 709. The operations 709 are substantially similar to the operations 634, as described with respect to FIG. 6.

In 710, the source eUICC 704 transmits the exported profile package, the public key part of the source one-time key pair, and the profile state to the target eUICC 1 706.

In 712, the target eUICC 1 706 fails to install the eSIM profile. Failure to install the eSIM profile may occur due to any number of issues, for example, the target eUICC 1 706 does not have enough memory, some bits of the eSIM profile are lost or corrupted, the target eUICC 1 706 loses power, etc.

In 714, the target eUICC 1 706 and the source eUICC 704 perform mutual eSIM export abort operations. The abort operations 714 conclude with the eSIM profile on the source eUICC 704 either disabled or enabled, and no eSIM profile on the target 1 eUICC 706. In some example embodiments, the abort operations may include the target eUICC 1 706 sending the source eUICC 704 an indication of the installation failure. In other example embodiments, the source eUICC 704 may simply not receive the installation stub described above and the lack of receipt of the installation stub may indicated to the source eUICC 704 that the target eUICC 1 706 has not successfully installed the eSIM profile.

At a later time, in 716, an eSIM export operation is triggered between the source eUICC 704 and the target eUICC 2 702. As described above, the target eUICC 2 702 may be the same eUICC as the eUICC 1 706, an additional eUICC on the same target UE, or an eUICC of a different target UE. Based on logic and operations described in the call flow 600, the source eUICC 704 has not deleted the eSIM profile because it has not received an install stub from the eUICC 1 706 (e.g., the profile installation result 622).

In operations 717, the target eUICC 2 702 and the source eUICC 704 perform operations substantially similar to those described in the operations 634 shown in FIG. 6.

In 718, the target eUICC 2 702 transmits the profile installation result 718 to the source eUICC 704. For the example shown in the call flow 700, the target eUICC 2 702 successfully installs the eSIM profile.

In 726, the target eUICC 2 702 verifies the signature of the source eUICC 704 and target EID.

In 728, the target eUICC 2 702 updates the profile to the disabled state

The operations 720, 722, 724, 726 and 728 are substantially similar to those described in the verify signature and EID 624, delete profile 626, send delete notification 628, verify signature 630, and mark profile in disabled state 632 described in the call flow 600.

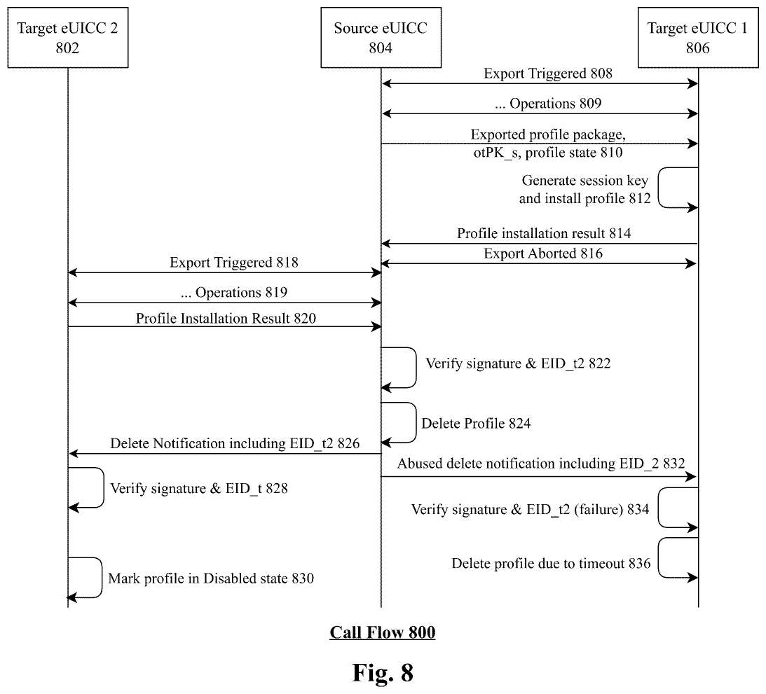

FIG. 8 shows a call flow 800 for transferring an eSIM profile including operations and logic for preventing abuse of delete stubs according to various example embodiments. The call flow 800 includes a target eUICC 2 802, source eUICC 804, and a target eUICC 1 806, which are substantially similar to the target eUICC 2 702, the source eUICC 704, and the target eUICC 1 706.

In 808, an eSIM export operation is triggered between the source eUICC 804 and the target eUICC 1 806.

In 809, the source eUICC 804 and the target eUICC 1 806 performs various operations 809. The operations 809 are substantially similar to the operations 634, as described with respect to FIG. 6.

In 810, the source eUICC 804 transmits the exported profile package, the public key part of the source one-time key pair, and the eSIM profile state. In 812, the target eUICC 1 806 generates a session key and installs the eSIM profile in the export state.

In 814, the target eUICC 1 806 transmits a profile installation result to the source eUICC 804.

In 816, the source eUICC 804 and the target eUICC 1 806 perform mutual eSIM export abort operations. This may occur, for example, if the connection between the source eUICC 804 and the target eUICC 1 806 degrades below a predetermined threshold. This may occur, in another example, if the user of target eUICC 1 806 deliberately disconnects the connection between the source eUICC 804 and the target eUICC 1 806 to manipulate the eUICC as shown in operation 828 below. The abort operations 816 conclude with the eSIM profile on the source eUICC 804 either disabled or enabled, and an unusable export eSIM profile on the target eUICC 1 806.

At a later time, in 818, an eSIM export operation is triggered between the source eUICC 804 and the target eUICC 2 804 The target eUICC 2 804 may be an additional eUICC on a target UE, or it may be included on a different target UE than the target UE associated with the target eUICC 1 806.

In 819, the source eUICC 804 and the target eUICC 2 802 perform various operations 819. The operations 819 are substantially similar to the operations 634, as described with respect to FIG. 6.

In 820, the target eUICC 2 802 transmits a profile installation result to the source eUICC 804.

In 822, the source eUICC 804 verifies the signature and the target 2 EID (i.e., EIDt2).

In 824, the source eUICC 804 deletes its installed eSIM profile.

In 826, the source eUICC 804 transmits a delete notification including the EIDt2 to the target eUICC 2.

In 828, the target eUICC 2 802 verifies the signature of the source eUICC 804 and target EID.

In 830, the target eUICC 2 802 updates the profile to the disabled state

Following 826, the same eSIM profile now exists on both on the target 1 eUICC 806 (in the export state) and on the target eUICC 2 802 (in the disabled or enabled state). A malicious actor may attempt to transmit a delete notification (i.e., a delete stub) to the target eUICC 1 806 in an attempt to transition the export state eSIM profile to a useable state (i.e., disabled or active) for malicious purposes. The call flow 800 shows the source eUICC 804 transmitting a malicious abused delete notification 832 including the EID_t2 to the target eUICC 1 806. This is only an example; it is possible that a clone of the delete notification 826 may be transmitted from a 3^{rd} party device (not shown).

In 834, the target eUICC 1 806 attempts to verify the signature and EID_t2, but this verification fails because it includes the EID_t2 (i.e., not its own EID_t1). This verification failure prevents the exported eSIM profile on the target eUICC 1 806 from transitioning to the active or disabled states.

In 836, the target eUICC 1 806 deletes the export state eSIM profile due to expiration of a timer initiated following the verification failure 830.

### EXAMPLES

In a first example, a method, comprising processing, based on signaling received from a source device with which a target device is engaging in an embedded subscriber identity module (eSIM) transfer process to transfer an eSIM profile to the target device, a first message comprising a source embedded identity document (EID) of the source device, generating, for transmission to the source device, a second message comprising a target EID of the target device and processing, based on signaling received from the source device, a third message comprising the eSIM profile and an identification of a first state that the eSIM profile is in on the source device, wherein the eSIM profile includes an Integrated Circuit Card Identification Number (ICCID).

In a second example, the method of the first example, further comprising installing the eSIM profile on the target device, wherein the eSIM profile is assigned a second state on the target device, the second state indicating the eSIM profile is installed but not usable on the target device.

In a third example, the method of the second example, wherein the eSIM profile is installed on an Embedded Universal Integrated Circuit Card (eUICC) of the target device.

In a fourth example, the method of the second example, further comprising generating, for transmission to the source device, an installation stub comprising the ICCID and the target EID, wherein the installation stub is transmitted based on eSIM profile being successfully installed on the target device.

In a fifth example, the method of the fourth example, further comprising processing, based on signaling received from the source device, a deletion stub comprising the target EID and the ICCID.

In a sixth example, the method of the fifth example, further comprising verifying the target EID included in the deletion stub matches the target EID of the target device, and transitioning the eSIM profile to a third state when the target EID included in the deletion stub matches the target EID of the target device.

In a seventh example, the method of the sixth example, wherein the third state indicates the eSIM profile is usable by the target device but is disabled.

In an eighth example, the method of the sixth example, further comprising transitioning the eSIM profile to a fourth state indicating the eSIM profile is usable and enabled on the target device.

In a ninth example, the method of the eighth example, wherein the transition of the eSIM profile to the fourth state is based on receiving user input to enable the eSIM profile.

In a tenth example, the method of the eighth example, wherein the transition of the eSIM profile to the fourth state is performed automatically by the target device at a time after transitioning the eSIM profile to the third state and is based on the first state indicating the eSIM profile was usable and enabled on the source device prior to the transfer.

In an eleventh example, the method of the second example, further comprising processing, based on signaling received from the source device, an abused delete notification message comprising a further target EID of a further target device, determining the further target EID included in the abused delete notification message does not match the target EID of the target device, preventing the eSIM profile from being transitioned from the second state based on the further target EID not matching the target EID and deleting the eSIM profile from the target device a predetermined time after receiving the abused delete notification message from the source device.

In a twelfth example, the method of the first example, wherein the target device is unsuccessful at installing the eSIM profile, the method further comprising deleting the eSIM profile from the target device a predetermined time after receiving the eSIM profile from the source device.

In a thirteenth example, the method of the first example, wherein the first state is an enabled state or a disabled state.

In a fourteenth example, the method of the first example, further comprising generating, for transmission to the source device, a target one-time key pair.

In a fifteenth example, the method of the fourteenth example, wherein the third message comprises a profile package including the eSIM profile, the indication of the first state and a source one-time key pair.

In a sixteenth example, the method of the fifteenth example, further comprising generating a session key based on the source one-time key pair and the target one-time key pair.

In a seventeenth example, a processor configured to perform any of the methods of the first through sixteenth examples.

In an eighteenth example, a user equipment (UE) operating as a target device configured to perform any of the methods of the first through sixteenth examples.

In a nineteenth example, a method, comprising processing, based on signaling received from a target device with which a source device is engaging in an embedded subscriber identity module (eSIM) transfer process to transfer an eSIM profile to the target device, a first message comprising a target embedded identity document (EID) of the target device, generating, for transmission to the target device, a second message comprising a source EID of the source device and preparing, for transmission to the target device, the eSIM profile, a third message comprising the eSIM profile and an indication of a first state of the eSIM profile on the source device, wherein the eSIM profile includes an Integrated Circuit Card Identification Number (ICCID).

In a twentieth example, the method of the nineteenth example, further comprising processing, based on signaling received from the target device, an installation stub comprising the ICCID and target EID, verifying the target EID received in the installation stub matches the target EID received in the first message and verifying the ICCID received in the installation stub matches the ICCID of the eSIM profile transmitted to the target device.

In a twenty first example, the method of the twentieth example, further comprising deleting the eSIM profile from the source device when the verification of the target EID and ICCID is successful.

In a twenty second example, the method of the twenty first example, wherein the eSIM profile is deleted from an Embedded Universal Integrated Circuit Card (eUICC) of the source device.

In a twenty third example, the method of the twenty first example, further comprising, in response to deletion of the eSIM profile, generating, for transmission to the target device, a deletion stub comprising the target EID and the ICCID.

In a twenty fourth example, the method of the nineteenth example, further comprising, prior to receiving an installation stub from the target device, processing, based on signaling received from a further target device, a fourth message comprising a further target EID of the further target device, generating, for transmission to the further target device, a fifth message comprising the source EID, preparing, for transmission to the further target device, the eSIM profile, wherein the eSIM profile includes the ICCID and is in the first state on the source device, processing, based on signaling received from the further target device, an installation stub comprising the ICCID and further target EID, verifying the further target EID received in the installation stub matches the further target EID received in the fourth message, verifying the ICCID received in the installation stub matches the ICCID of the eSIM profile transmitted to the further target device, deleting the eSIM profile from the source device when the verification of the further target EID and ICCID is successful and, in response to deletion of the eSIM profile, generating, for transmission to the further target device, a deletion stub comprising the further target EID and the ICCID to the further target device.

In a twenty fifth example, the method of the twenty fourth example, further comprising generating, for transmission to the further target device, an abused delete notification message comprising the further target EID to the target device.

In a twenty sixth example, the method of the nineteenth example, wherein the first state is an enabled state or a disabled state.

In a twenty seventh example, the method of the nineteenth example, further comprising processing, based on signaling received from the target device, a target one-time key pair, generating a source one-time key pair and generating a session key, based on at least the target one-time key pair and the source one-time key pair, wherein the third message comprises a profile package including the eSIM profile, the indication of the first state and the source one-time key pair.

In a twenty eighth example, a processor configured to perform any of the methods of the nineteenth through twenty seventh examples.

In an twenty ninth example, a user equipment (UE) operating as a source device configured to perform any of the methods of the nineteenth through twenty seventh examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signaling received from a source device with which a target device is engaging in an embedded subscriber identity module (eSIM) transfer process to transfer an eSIM profile to the target device, a first message comprising a source embedded identity document (EID) of the source device;
generate, for transmission to the source device, a second message comprising a target EID of the target device; and
process, based on signaling received from the source device, a third message comprising the eSIM profile and an identification of a first state that the eSIM profile is in on the source device, wherein the eSIM profile includes an Integrated Circuit Card Identification Number (ICCID).

2. The apparatus of claim 1, wherein the processing circuitry is further configured to:
install the eSIM profile on the target device, wherein the eSIM profile is assigned a second state on the target device, the second state indicating the eSIM profile is installed but not usable on the target device.

3. The apparatus of claim 2, wherein the eSIM profile is installed on an Embedded Universal Integrated Circuit Card (eUICC) of the target device.

4. The apparatus of claim 2, wherein the processing circuitry is further configured to:
generate, for transmission to the source device, an installation stub comprising the ICCID and the target EID, wherein the installation stub is transmitted based on eSIM profile being successfully installed on the target device.

5. The apparatus of claim 4, wherein the processing circuitry is further configured to:
process, based on signaling received from the source device, a deletion stub comprising the target EID and the ICCID.

6. The apparatus of claim 5, wherein the processing circuitry is further configured to:
verify the target EID included in the deletion stub matches the target EID of the target device; and
transition the eSIM profile to a third state when the target EID included in the deletion stub matches the target EID of the target device.

7. The apparatus of claim 6, wherein the third state indicates the eSIM profile is usable by the target device but is disabled.

8. The apparatus of claim 6, wherein the processing circuitry is further configured to:
transition the eSIM profile to a fourth state indicating the eSIM profile is usable and enabled on the target device.

9. The apparatus of claim 8, wherein the transition of the eSIM profile to the fourth state is based on receiving user input to enable the eSIM profile.

10. The apparatus of claim 8, wherein the transition of the eSIM profile to the fourth state is performed automatically by the target device at a time after transitioning the eSIM profile to the third state and is based on the first state indicating the eSIM profile was usable and enabled on the source device prior to the transfer.

11. The apparatus of claim 2, wherein the processing circuitry is further configured to:
process, based on signaling received from the source device, an abused delete notification message comprising a further target EID of a further target device;
determine the further target EID included in the abused delete notification message does not match the target EID of the target device;
prevent the eSIM profile from being transitioned from the second state based on the further target EID not matching the target EID; and
delete the eSIM profile from the target device a predetermined time after receiving the abused delete notification message from the source device.

12. The apparatus of claim 1, wherein the target device is unsuccessful at installing the eSIM profile, wherein the processing circuitry is further configured to:
delete the eSIM profile from the target device a predetermined time after receiving the eSIM profile from the source device.

13. The apparatus of claim 1, wherein the first state is an enabled state or a disabled state.

14. The apparatus of claim 1, wherein the processing circuitry is further configured to:
generate, for transmission to the source device, a target one-time key pair.

15. The apparatus of claim 14, wherein the third message comprises a profile package including the eSIM profile, the indication of the first state and a source one-time key pair.

16. The apparatus of claim 15, wherein the processing circuitry is further configured to:
generate a session key based on the source one-time key pair and the target one-time key pair.

17. A method, comprising:
processing, based on signaling received from a source device with which a target device is engaging in an embedded subscriber identity module (eSIM) transfer process to transfer an eSIM profile to the target device, a first message comprising a source embedded identity document (EID) of the source device;
generating, for transmission to the source device, a second message comprising a target EID of the target device; and
processing, based on signaling received from the source device, a third message comprising the eSIM profile and an identification of a first state that the eSIM profile is in on the source device, wherein the eSIM profile includes an Integrated Circuit Card Identification Number (ICCID).

18. The method of claim 17, further comprising:
installing the eSIM profile on the target device, wherein the eSIM profile is assigned a second state on the target device, the second state indicating the eSIM profile is installed but not usable on the target device.

19. The method of claim 18, wherein the eSIM profile is installed on an Embedded Universal Integrated Circuit Card (eUICC) of the target device.

20. The method of claim 18, further comprising:
generating, for transmission to the source device, an installation stub comprising the ICCID and the target EID, wherein the installation stub is transmitted based on eSIM profile being successfully installed on the target device.
